(19) United States
(12) Patent Application Publication
(10) Pub. No.: US 2024/0116209 A1
(43) Pub. Date: Apr. 11, 2024

(54) METHOD FOR MANUFACTURING A WOOD-POLYMER COMPOSITE

(71) Applicant: Leko Labs S.A., Foetz (LU)

(72) Inventors: François-Xavier CORDIER, Strassen (LU); Marion NOËL, AVENCHES (CH); Charlotte GROSSE, NANCY (FR)

(21) Appl. No.: 18/264,566

(22) PCT Filed: Feb. 8, 2022
(86) PCT No.: PCT/EP2022/052986

§ 371 Date: Aug. 7, 2023

(30) Foreign Application Priority Data
Feb. 9, 2021 (EP) 21315020.4

(51) Int. Cl. B27K 3/15; B27K 3/02; B27K 3/08; B27K 3/36

(52) U.S. Cl. CPC B27K 3/156; B27K 3/0278; B27K 3/08; B27K 3/36

(57) ABSTRACT

The present invention relates to the manufacturing a wood-polymer composite. It is directed to a method for manufacturing such a composite, including the provision of a wood element (1), the impregnation of the wood element with a lactic acid water-based solution (2), and then the thermal treatment of the impregnated wood element (3) at a heating temperature higher than a nominal temperature where the in-situ polymerization of the lactic acid is initiated, in order both to induce the diffusion of the lactic water-based solution acid water-based solution within the impregnated wood element and to initiate the in-situ polymerization of the lactic acid. According to the invention, the thermal treatment (3) includes the acceleration of the increase of the heating temperature and/or the decreasing of the nominal temperature.

### BACKGROUND OF THE INVENTION

The present invention relates to a method for manufacturing a wood-polymer composite, where wood material is impregnated with a polymerizable organic agent, in order to strengthen the wood material (notably density, dimensional stability, durability, hardness, wear resistance and/or elastic modulus). Such wood modified material is particularly useful for manufacturing wooden buildings which are made of a series of wooden panels, but also for many other woodworks such as decking, cladding, flooring, joinery and furniture.

In this technical field, it is appreciated that only few wood species are usually chemically modified at industrial scale, as chemical modification is efficient only when the chemicals can be homogenously diffused along the wood volume. Now, only few wood species are both impregnable and homogenous enough to allow such a good diffusion of chemicals. Consequently, the chemical modification of wood at industrial scale is known to be limited to very specific wood species, which cannot necessarily be present anywhere and which can be too expensive for certain applications. As an example, radiata pine, alder, southern yellow pine, Scots pine and maple display a certain homogenous quality. However, wood chemical modification or impregnation processes rely mostly on highly permeable wood, essentially constituted of radiata pine cultivated in New Zealand.

In this regard, several techniques are known to impregnate and/or chemically modify wood. For instance, the product ACCOYA® from TITAN WOOD LIMITED is based on “acetylation reaction”, i.e. on the impregnation of acetic anhydride into a wood structure. The reaction is initiated by heat. It releases acetic acid as a co-product that must be eliminated in the process because of its unpleasant smell and acidity. The final product is a modified wood obtained by esterification of its hydroxyl groups by the acetyl groups of the acetic anhydride.

Another known process, named KEBONY®, was developed by KEBONY AS and is disclosed in document WO 2011/1444608 A1. This known process is based on “furfurylation reaction”, i.e. the impregnation of furfuryl alcohol into the wood structure. The reaction, again, is initiated by heat. This time, the final product is a modified wood obtained by grafting of furfuryl alcohol to hemicelluloses and lignin, and the polycondensation of furfuryl alcohol in the wood structure.

Both known processes have the advantage of strengthening the wood so it can be used for wood construction purposes (i.e. buildings, but also decking, cladding, flooring, joinery and furniture). However, as mentioned above, the drawback of such known processes is that they require a homogenous wood material as a starting point mostly imported from New Zealand which has a significant environmental cost.

Despite R&D efforts, other wood species such as hardwoods are usually not chemically treated because of their complexity to receive chemical treatment. For instance, Beech wood is widely available in Europe, but it is under-exploited, since it is considered as not resistant to pathogenic agents, and it demonstrates high dimensional change with relative humidity variations. Even though Beech wood is known to be very porous and easy to impregnate, the impregnation and treatment of such wood usually leads to strong dimensional deformation.

There is thus a need for a method for chemically modifying hardwood such as Beech wood in order to increase its resistance to pathogenic agents and to stabilize its dimensions, so that it can be exploited and valorized.

To do so, several techniques were developed and tested. This is the case of the chemical modification by in-situ polymerization of a polymerizable organic agent such as lactic acid. Here, the organic agent can be polymerized in the wood cell wall (in-situ). This consists in a two-step process of impregnation and then a polymerization reaction. The first step is the impregnation of a water-based solution of lactic acid into the wood structure, under vacuum, at room temperature. Then the second step is a thermal treatment of the impregnated wood, in a ventilated oven at a high temperature (more than 120° C.). This heating step is carried out both to induce the diffusion of the solution into the wood cell wall, and to initiate the polycondensation of the lactic acid. The resulting material is a wood-polylactic acid composite.

However, this chemical modification has several drawbacks. First, the lactic acid polymerization requires high temperature (usually up to 200° C.) in order to reach a high enough degree of polymerization for applications in the plastic industry. Such a high temperature for wood treatment is only possible in closed systems under inert or saturated steam atmosphere for fire safety. Second, the wood material interferes with the polycondensation, which limits the polymerization and the transformation of lactic acid into a polymer within the wood cell wall, which, combined with a temperature lower than the lactic acid polymerization temperature (i.e. the nominal temperature where the polymerization of lactic acid occurs), reduces the modification process efficiency.

To overcome some of these drawbacks, it was attempted to heat the wood in a closed system under saturated steam rather than in an open system. However, the in-situ polymerization of lactic acid is prevented by humidity.

Another suggested solution was to conduct a mild heat treatment, i.e. at no more than 160° C., but for an extended duration of time, i.e. 48 hours. This softer and longer heating supports the in-situ polymerization of lactic acid. It thus allows the lactic acid to reach a high enough degree of polymerization to strengthen the properties of the impregnated wood material. However, this heating also amplifies degradation of wood during the process, thereby decreasing the mechanical properties of wood and limiting the benefits of the higher degree of polymerization.

Finally, thermal treatment without impregnation is also a well-known process. It consists in a controlled pyrolysis of solid wood by application of a high temperature (180 to 240° C.) for a certain time (several days). This process allows to degrade and eliminate part of the wood hemicelluloses, which are the most hydrophilic compounds of wood. But it still has the drawback that thermal treatment induces substantial loss of mechanical resistance, and that it is not suitable for all types of wood species. For instance, Beech wood is not responding well to such a thermal treatment.

Overall, the heat treatment of wood without impregnation is known to induce a loss of mechanical resistance of wood. In this context, there is thus a need for finding a balance between the degree of in-situ lactic acid polymerization (which improves the wood's properties) and the risk of wood degradation (which voids the improvement of the wood's properties).

It is also noteworthy that other existing wood chemical modification solutions exist. These solutions involve mostly cross-linking reactions or use efficient non bio-based catalysts to increase the reaction speed, which in turn makes the long thermal treatment unnecessary. For instance, the product LIGNIA® from FIBRE 7 UK LIMITED carries out an impregnation and reticulation of fossil-based molecules into the wood structure. This process allows to reduce the sensitivity of wood to water, humidity and fire, and is used for applications where a high resistance to water or fire is needed (for example, yacht decking). Another process named BELMADUR®, from BASF SE, consists of the impregnation of DMDHEU (Dimethyloldihydroxyethyleneurea), a big volume fossil-based molecule, into the wood structure. This process allows to improve the wood's resistance to water, as DMDHEU will occupy the void space in the wood structure that water would infiltrate otherwise. In these two solutions, there is no need to carry out a long thermal treatment. However, these solutions have a significant drawback. Indeed, they both involve the use of chemicals from petroleum resources.

Consequently, there is also a need for a method for chemically modifying wood—and improving its properties—in a cost-efficient manner and without any use of petroleum resources.

### SUMMARY OF THE INVENTION

It is accordingly an object of the present invention to provide a method for manufacturing a wood-polymer composite which improves the wood's properties (its resistance to pathogenic agents, and/or its dimensional stability regarding water and humidity), which avoids the use of petroleum resources, which is cost effective while being flexible, and which is suitable for the chemical modification of hardwood such as Beech wood.

To this end, the present invention relates to a method for manufacturing a wood-polymer composite. The method includes the provision of a wood element, then the impregnation of the wood element with a lactic acid water-based solution. Then the method includes the thermal treatment of the impregnated wood element at a heating temperature (T) higher than a nominal temperature where the in-situ polymerization of the lactic acid is initiated (T₀), in order both to induce the diffusion of the lactic acid water-based solution within the impregnated wood element and to initiate the in-situ polymerization of the lactic acid. According to the invention, the thermal treatment includes the acceleration of the increase of the heating temperature (T) and/or the decreasing of the nominal temperature (T₀).

Whereas the known solutions for in-situ lactic acid polymerization carried out a softer and longer thermal treatment, thereby slowing down the polymerization, the present invention instead proposes that the reaction kinetics are increased, so that the final degree of polymerization can be either reached in a shorter period of time, or significantly increased in the already reported thermal treatment duration. Reducing the heating time allows to limit the mechanical, physical and chemical degradation of wood otherwise induced by the heating of wood. As a second option, increasing the final degree of polymerization in the already reported thermal treatment duration allows to compensate the wood degradation induced by heating by the longer size of the in-situ polymerized lactic acid. As a result, the present invention recognizes that in-situ lactic acid polymerization is a suitable technique to chemically modify wood, and makes it possible to implement this polymerization reaction with a proper balance between the improvement of the wood's properties (thanks to polymerization) and the degradation of the wood's properties (due to the heating). By doing so, the present invention allows to control the wood's degradation, and to improve the wood's properties.

In addition, as the invention indeed implements the technique of in-situ lactic acid polymerization, it allows to avoid using chemicals from petroleum resources.

Moreover, as the invention limits the degradation of wood during the thermal treatment, it overcomes the major hurdle of hardwoods such as Beech wood, i.e. the fact that they are not permeable or that they display high swelling and shrinkage values (either in exposure to humidity, or by impregnation). This hurdle explained why such hardwoods were not considered as good candidates for chemical modification, despite their wide availability in some territories such as Europe and their relatively low cost. The invention makes thus it possible to use in-situ lactic acid polymerization on such hardwoods, and then to chemically strengthen such wood species.

The invention has additional advantages. First, the impregnation and heating process is relatively simple and fast, which makes it less expensive compared to the other known processes. Second, the invention provides for a higher flexibility, as many parameters can be set, such as speed of polymerization, temperature and duration of the microwave radiations, pressure and duration of the vacuum conditions, power, so that the manufacturer can define several wood quality classes depending on the sets of parameters that it can select.

In an embodiment, the acceleration of the increase of the heating temperature is achieved by a thermal treatment by microwaves radiations. The effect of this type of thermal treatment is to initiate a fast increase in temperature from the core of the wood material. This will increase the rate of polymerization while reducing the wood exposure to heat. It will thus limit the degradation of the wood component.

In this embodiment with microwaves radiations, the frequency of microwave radiations is advantageously more than 500 MHz, preferably between 1 and 3 GHz. Also, the thermal treatment by microwaves radiations preferably takes place during 2 to 72 hours, at a temperature between 140 to 180° C.

It is preferable that such thermal treatment by microwaves radiations takes place within a microwave oven or a microwave tunnel.

In an embodiment, the decreasing of the nominal temperature is achieved by a thermal treatment under vacuum conditions. The effect of vacuum is that the pressure will impact the kinetics of the chemical reaction, so water evaporation will occur at a nominal temperature of around 70° C. instead of 100° C. As a result, the polymerization of lactic acid happens at a lower temperature, so the polymerization rate increases, thereby allowing either to reach the desired wood properties in a shorter period of time or at a lower temperature, or to reach a higher degree of lactic acid polymerization for the same period of time and temperature. This provides the manufacturer with many treatment options (e.g. shortening the heating duration, and/or lowering the heating temperature) while increasing the polymerization rate.

In this embodiment under vacuum conditions, the pressure can be between 100 and 500 mbar, preferably around 300 mbar. The thermal treatment under vacuum preferably takes place during 24 to 72 hours, at a temperature between 140 to 180° C.

In these embodiments, it is particularly advantageous to add a step of pre-thermal treatment before the thermal treatment. To do so, as a first alternative, after the wood element is impregnated and before it is thermally treated, the impregnated wood element is pre-heated so as to increase its temperature and then to reduce the time need for the impregnated wood element to reach the polymerization temperature during the thermal treatment. The advantage of this thermal preparation of the wood element is that it will have a higher temperature before the heating step is carried out according to the invention. By doing so, the wood will need less time to be polymerized, so it will be exposed to the thermal (degrading) treatment during a shorten period of time. The wood will thus be less degraded by the thermal treatment of the invention. For pre-heating with micro-wave, a pre-treatment of a duration between 20 minutes to 4 hours, to reach 160° C. (according to the desired temperature ramp) is advantageous.

Alternatively or additionally, as a second alternative, it is advantageous to add a step of vacuum pre-drying treatment before the thermal treatment. In this case, after the wood element is impregnated and before it is thermally treated, the impregnated wood element is pre-dried so as to reduce the water content of the impregnated wood element and then to reduce the amount of energy necessary to evaporate water before the polymerization starts. Here, the preparation of the impregnated wood allows to reduce the amount of water before the thermal treatment occurs. As water must be evaporated before the polymerization starts, the pre-drying starts the polymerization sooner, and then allow to reach the desired degree of polymerization in a shorter period of time, thereby shortening the heating (and degradation) of the impregnated wood.

Advantageously, this step of vacuum pre-drying of the wood element takes place at a low temperature, preferably between 60 and 80° C.

Regarding the impregnation step, it is preferable that the impregnation with a lactic acid water-based solution is made under vacuum. The vacuum allows to remove the air from the void spaces in wood. Indeed, when the pressure is back to atmospheric pressure, the liquid is sucked into the wood voids. Thanks to vacuum, the invention avoids that the liquid diffusion in wood is slow and proceeds only by capillarity.

In addition, for a proper lactic acid impregnation, it is preferable that the lactic acid water-based solution includes more than 70% of lactic acid.

Finally, the invention also concerns a wood-polymer composite obtainable by implementing the method according to the invention. It also relates to a construction element comprising a set of lamellas made of the wood-polymer composite according to the invention.

### BRIEF DESCRIPTION OF DRAWINGS

Other features and advantages of the invention will become apparent from the following description of embodiments of the invention, given for illustrative purposes, by reference to the annexed drawings.

FIG. 1 is a diagram representing the different steps implemented according to several embodiments of the present invention.

FIG. 2 is a diagram representing a two-step process according to prior art.

FIG. 3 is a diagram representing a two-step process according to the invention.

### DETAILED DESCRIPTION OF THE INVENTION

Known Methods for In-Situ Polymerization of Lactic Acid

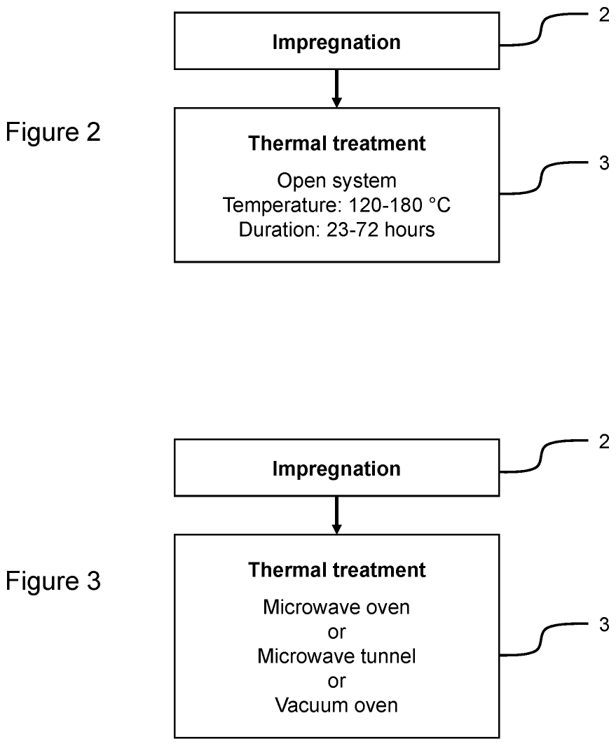

As mentioned above, the chemical modification of a wood element by in-situ polymerization of lactic acid was known before the filing date, since it was investigated and published in peer-reviewed journals. An example of such known process is given in reference to FIG. 2.

Basically, this known process consisted in an impregnation of a wood element under vacuum at room temperature by a water-based solution of lactic acid, followed by a thermal treatment in ventilated oven at temperature in the range of 120 to 180° C. The thermal treatment (or heating phase) will both induce the diffusion of the product in the wood structure (i.e. in the wood cell wall) and initiate the chemical reaction, i.e. the polycondensation of lactic acid in the wood structure.

There are many publications in relation to in-situ polymerization of lactic acid in a wood structure. These publications include, where more details on this process of in-situ polymerization can thus be found:
Noël et al., 2009a., “Lactic acid/wood-based composite material. Part 1: synthesis and characterization”, Bioresource Technology, 100 (20), 4711-4716.
Noël et al., 2009b., “Lactic acid/wood-based composite material. Part 2: Physical and mechanical performance”, Bioresource Technology, 100 (20), 4717-4722.
Noël et al., 2015, “Evaluating the extent of bio-polyester polymerization in solid wood by thermogravimetric analysis”, Journal of Wood Chemistry and Technology, 35, 325-336.
Grosse et al., 2018, “Influence of water and humidity on wood modification with lactic acid”, Journal of Renewable Materials, 6 (3), 259-269.
Grosse et al., 2019, “Optimizing chemical wood modification with oligomeric lactic acid by screening of processing conditions”, Journal of Wood Chemistry and Technology, 39, 385-398.

In these publications, a lactic acid in-situ polymerization process is disclosed, then a series of measurements were made on the obtained wood-polymer composite, notably the following parameters: Anti-Swelling Efficiency (ASE), Equilibrium Moisture Content (EMCt), Leaching, Biological Resistance.

For instance, the publication “Optimizing chemical wood modification with oligomeric lactic acid by screening of processing conditions” describes the following in-situ polymerization process. First, wood samples are cut from Beech wood (i.e. Fagus sylvatica L.) and oven-dried to constant weight, prior to impregnation. Second, a L(+)-Lactic acid solution (85%) is provided, and lactic acid oligomers (OLA) are prepared. Third, oligomeric polyesters are synthesized by direct polymerization under vacuum, using a four-necked flask fitted with a magnetic stirrer and reflux condenser linked to an inline cold trap and vacuum pump. This solution is then impregnated in the wood samples (step 2 on FIG. 2). The solution is heated under a reduced pressure (150 mbar). Thermometers are used in order to control the polymerization reaction and the heating temperature. The temperature is first gradually increased to 90° C. as an initial distillation step of 1 hour (step 3 on FIG. 2). The initial oligomerisation step involved gradually increasing the temperature to 140° C. for 2.5 hours. Fifth, wood samples are oven-dried at 103° C. to constant weight prior to treatment. Sixth, wood samples are immersed in liquid oligomers (OLA) at room temperature. Containers are placed in a vacuum oven under reduced pressure (150 mbar) for 10 to 15 minutes, then under the atmospheric pressure for 10 to 15 minutes. The impregnated samples are then wiped and set on aluminum foil in a ventilated oven at different temperatures for different durations. Finally, curing in humid atmosphere is carried out in a reactor, with a controlled steam pressure system. Then dry curing is carried out in a ventilated oven.

Another example of such known in-situ polymerization process is described below. In this example, Beech wood pieces are provided. These pieces have a size of of 130×30×300 mm³ and a moisture content of 18%. These Beech wood pieces are impregnated under vacuum/pressure process with a 88% lactic acid solution, at a 95% impregnation yield (step 2 on FIG. 2). The impregnation is carried out under vacuum (down to 150 mbar). The impregnated wood is thermally treated in convection oven set, at a temperature of 160° C., for a duration of 48 hours (step 3 on FIG. 2). This thermal treatment leads to a swelling of around 13% (due to lactic acid diffusion into the wood structure) and to a shrinkage of around 14% (due to the wood component degradation during thermal treatment). When the curing is complete, the wood-polymer composite can be removed.

In this example, the resulting wood-polymer composite contains polymers in the cell wall replacing part of the wood polymers. These polymers cannot be extracted from the structure, even under hard extraction conditions (i.e. hot chloroform under pressure) more than 50%. The anti-swelling efficiency of this material reaches 70% when measured under wet conditions (23° C. and 99% relative humidity). Among the mechanical properties, the rolling shear strength reaches in average 33.6 kN.

In-Situ Polymerization of Lactic Acid According to the Invention

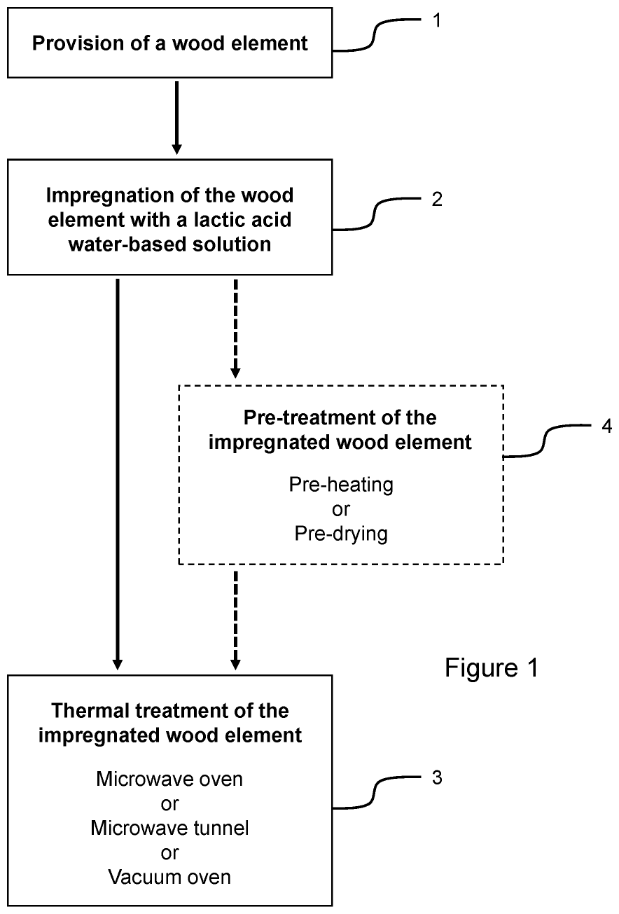

Referring to FIGS. 1 and 3, a method for manufacturing a wood-polymer composite is disclosed. Starting from a wood element (step 1 on FIG. 1), the two main steps of the invention are the impregnation of the wood element with a lactic acid water-based solution (step 2 on FIGS. 1 and 3), then the thermal treatment of the impregnated wood element (step 3 on FIGS. 1 and 3). It will be explained below that an additional step can be contemplated, which consists in pre-treatment of the impregnated wood element before the thermal treatment (step 4 on FIG. 1).

Compared to the known methods, the method according to the invention can not only improve the wood's properties (notably its resistance to pathogenic agents, and its dimensional stability regarding water and humidity), but also avoid the use of petroleum resources. In addition, this method is cost effective, flexible, and suitable for the chemical modification of hardwoods such as Beech wood.

Step 1: Provision of a Wood Element

Step 1 consists in providing a wood element to be strengthened. For instance, a suitable wood for the implementation of the invention is European Beech (Fagus sylvatica), or maple (Acer pseudoplatanus), but other wood species can be considered. The pieces can simply be cut from timbers. Prior to impregnation, these wood pieces can be oven-dried to constant weight. This step is shown on FIG. 1.

Step 2: Impregnation with a Lactic Acid Water-Based Solution

Step 2 consists in impregnating the wood element with a lactic acid water-based solution. To do so, a lactic acid water-based solution is used. This solution should include more than 70% of lactic acid, and preferably more than 85%. As an example, such solution can be sourced from Sigma-Aldrich (Switzerland). This step is shown on FIGS. 1 and 3. A comparison between FIGS. 2 and 3 emphasizes that the principle of impregnation is known in the art.

Preferably, the impregnation of the wood element with the lactic acid water-based solution can be made under vacuum. Any conventional technique may be used in this regard. For instance, the wood element can be placed in an autoclave, and a vacuum with a pressure between 10 to 30 mbar can be established, prior to filling the vessel with the lactic acid water-based solution. When the solution is in, atmospheric pressure is re-established and then an overpressure is produced, which makes the lactic acid impregnate the wood element. The overpressure can be maintained for a specific time. Impregnating solutions are disclosed in several prior art documents, for instance WO 2004/011216 A1 and WO 2011/144608 A1, the disclosures of which are incorporated into this specification by reference in this regard.

During the impregnation, the wood element is impregnated with the lactic acid water-based solution, which means that the wood cell lumens are filled.

Step 3: Thermal Treatment

Step 3 consists in performing a thermal treatment of the impregnated wood element, at a specific heating temperature T, during a specific duration D. This step is shown on FIGS. 1 and 3. A comparison between FIGS. 2 and 3 emphasizes that the thermal treatment of the invention differs from the art.

Conventionally, this step is intended to induce the diffusion of the lactic acid water-based solution into the wood cell wall, and to initiate the polycondensation of the lactic acid. After this initiation, the polymerization can occur during the time the heating of the wood is maintained. In this regard, the heating temperature T must reach the lactic acid polymerization temperature, which is referred to as nominal temperature T₀, i.e. the temperature where the polymerization of lactic acid is initiated. In ambient air, the nominal temperature T₀ is known to be about 120° C. The duration D of the thermal treatment, i.e. the period of time when the heating temperature T is maintained, allows the polymerization to occur for a long enough period of time to reach the desired degree of polymerization.

According to the invention, the thermal treatment of step 3 is implemented in two independent ways, which have in common that they both allow to increase the efficiency of the polymerization reaction.

These alternative embodiments of the thermal treatment according to the invention are all methods for fast polymerization rate. Indeed, the thermal treatment by microwave radiations (first embodiment) will accelerate the polymerization reaction, by accelerating the increase of the in-situ temperature T. The thermal treatment under vacuum conditions (second embodiment) will accelerate the reaction by decreasing the characteristic temperature, i.e. the above-mentioned nominal temperature T₀, thereby increasing the reaction kinetics. Both embodiments have the advantage that they show low inertia, while prior art thermal treatments required more time to induce and maintain the polymerization reaction.

During the thermal treatment, the lactic acid water-based solution will diffuse into the anatomic structure of the wood element, i.e. into the wood cell walls.

### First Embodiment of Step 3: Microwaves Radiations

The first way to perform the thermal treatment is to use microwaves radiations in order to accelerate the increase of the heating temperature T.

Preferably, the frequency of the microwave radiations is more than 500 MHz, preferably between 1 and 3 GHz, the heating temperature T is between 140 to 180° C., and the treatment duration D is between 2 to 72 hours. The manufacturer can vary these parameters to determine the speed of the polymerization reaction.

In this embodiment, the thermal treatment by microwaves radiations can take place either within a microwave oven, or within a microwave tunnel. Practically, after impregnation of wood with the lactic acid water-based solution, the impregnated wood is inserted into a microwave oven or a microwave tunnel.

A detailed example of this first embodiment is provided below.

In this example, Beech wood samples are provided, with dimensions 135×41×750 mm³ and 8% moisture content. These wood samples are impregnated under vacuum with a 88% lactic acid water-based solution The average impregnation yield is 67%. Then, several thermal treatments are carried out under microwave radiations, at a radiation frequency of 915 MHz or 2.45 GHz, with many possible power densities and heating durations.

With all these parameters, the treatment leads to a final weight percent gain of around 28% (polymer cured in wood structure). The lactic acid diffusion into the wood cell wall is improved by around 6% wood swelling during the curing step. The anti-swelling efficiency is measured at around 30% under wet conditions (23° C. and 99% relative humidity). The moisture exclusion efficiency is around 30%, under the same conditions, with an exposure during 200 hours.

The effect of this thermal treatment is that microwave radiations initiate a fast increase in temperature from the core of the material. It will be appreciated that this temperature increase will depend on the material density and the water content. These radiations reduce the duration of the wood heating accordingly, so the degradation of the wood element is limited.

### Second Embodiment of Step 3: Vacuum Conditions

The second way to perform the thermal treatment according to the invention is to perform the thermal treatment under vacuum conditions in order to decrease the nominal temperature T₀ where the in-situ polymerization of the lactic acid is initiated.

Preferably, the pressure generated by the vacuum conditions is between 100 and 500 mbar, preferably around 300 mbar. The thermal treatment can take place at a temperature T between 140 to 180° C., for a duration D between 24 and 72 hours,

In this embodiment, the thermal treatment under vacuum conditions can take place within a vacuum oven. Practically, after impregnation of wood with the lactic acid water-based solution, the impregnated wood is inserted into a vacuum oven, with the appropriate pressure.

In this embodiment, the pressure impacts the chemical reaction kinetics by shifting the equilibrium temperatures. Water evaporation happens at around 70° C. at a pressure of 300 mbar instead of 100° C. at a usual atmospheric pressure of 1 013.25 mbar. This means that the lactic acid polymerization will start at a lower temperature, i.e. at around 90° C. instead of 120° C.

This second embodiment can provide one of the two following effects, at the choice of the manufacturer (depending on the heating temperature and the duration he will select). On the one hand, it makes it possible to reach the same wood properties as those obtained with known thermal treatments in open system, but in a shorter time, and possibly at a lower temperature. On the other hand, the manufacturer can decide to work on the same production parameters (for instance at a temperature of 160° C. and for a duration of 48 hours), to reach a higher degree of polymerization of lactic acid in wood, which improves the final properties of the wood-polymer composite. Indeed, a higher degree of polymerization will compensate the degradation of the mechanical properties of the wood-polymer composite.

A detailed example of this second embodiment is provided below.

In this example, Beech wood samples are provided, with dimensions 130×45×(250 to 750) mm³ and 8% moisture content. These wood samples are impregnated under vacuum with an 88% lactic acid water-based solution The average impregnation yield is 69%. Then thermal treatments is carried out under vacuum, respecting the following cycle: increase of temperature up to 160° C. in 14 hours at 800 mbar, then instantaneous decrease of pressure to 250 mbar (maintaining the temperature at 160° C.) maintained for 40 hours, then decrease of temperature to 80° C. and increase in pressure up to 1000 mbar in 2 hours.

With all these parameters, the treatment leads to a final weight percent gain of around 17% (polymer cured in wood structure). The lactic acid diffusion into the wood cell wall is improved by around 5% wood swelling during the curing step. The anti-swelling efficiency is measured at around 68% under wet conditions (23° C. and 99% relative humidity). The moisture exclusion efficiency is around 52%, under the same conditions, with an exposure during 500 hours. At the end of these 500 hours, the reference samples of untreated wood show a swelling value of 10%, whereas the treated samples display only 3% swelling. Some samples have been exposed to the same vacuum thermal treatment to quantify the effect of lactic acid. Those samples display the same 10% swelling as the reference, and no ASE nor MEE. Young modulus and bending strength have been measured as 16.971 MPa and 83 MPa respectively for wood treated under the conditions described above, while the samples exposed to vacuum thermal treatment only (no chemical impregnation) display 13.258 MPa and 77 MPa respectively.

Step 4: Pre-Treatment

Step 4 consists in a pre-treatment of the impregnated wood element. This step occurs after the impregnation and before the thermal treatment. This intermediary step is performed to increase the whole process efficiency. It may thus be especially suitable for applications where a long thermal treatment is favorable. It is shown on FIG. 1, in a dashed square, to emphasize the fact that it can be added as an intermediary step. Several such intermediary steps can even be contemplated.

Two embodiments of this pre-treatment step can be contemplated.

### First Embodiment of Step 4: Pre-Heating

In the first embodiment, the impregnated wood element is pre-heated. This allows to increase the temperature of the impregnated wood element. This allows in turn to reduce the time needed for the impregnated wood element to reach the nominal temperature T₀ during the thermal treatment.

For instance, after impregnation, the pre-heating of the impregnated wood element is made by microwave radiations. Practically, the impregnated wood element is placed within a fast microwave oven. This allows a fast temperature increase of the material before entering the thermal treatment autoclave. Indeed, wood is an insulating material harder to heat than the metallic autoclave. Therefore, increasing the system temperature from 20° C. to 160° C. takes significant time by convective heating process, depending on the volume to heat. Reducing this time by carrying out a fast microwave pre-heating of impregnated wood thus increases the process efficiency.

In addition, using microwave radiations under vacuum can remove the water in excess while increasing the temperature. This thus allows to start the actual thermal treatment step in the autoclave with the best prepared material, i.e. with less water in excess, for the highest process efficiency.

### Second Embodiment: Pre-Dried

In the second embodiment, the impregnated wood element is vacuum pre-dried. This allows to reduce the water content of the impregnated wood element before the thermal treatment. This in turn allows to reduce the amount of energy necessary to evaporate water before the polymerization starts, thereby accelerating the thermal treatment as the reaction can start right away.

Preferably, this step of vacuum pre-drying takes place at a low temperature, preferably between 60 and 80° C., and in any event at a temperature which is less than the temperature T which is used during the step of thermal treatment. The vacuum pre-drying has indeed the advantage that it can be carried out at a temperature lower than usual wood drying.

A detailed example of pre-drying step is given below.

In this example, Beech wood pieces are provided, with dimensions of 130×30×300 mm³ and around 18% moisture content. These pieces are impregnated under vacuum/pressure process with an 88% lactic acid water-based solution. This results in an impregnation yield of around 95%. The pieces are then stored in an atmosphere with a temperature of 22.5° C. and a relative humidity of 46.5%.

Then, after 17 days, it is measured that the wood pieces had a weight loss of 22.5%, which corresponds to 12% water in the lactic acid solution and a stabilization of wood at around 8.5% moisture content. This amounts to a loss of around 10% of the moisture content which was initially in wood.

1. A method for manufacturing a wood-polymer composite, including the provision of a wood element (1), the impregnation of the wood element with a lactic acid water-based solution (2), and then the thermal treatment of the impregnated wood element (3) at a heating temperature (T) higher than a nominal temperature where the in-situ polymerization of the lactic acid is initiated (T₀), in order both to induce the diffusion of the lactic acid water-based solution within the impregnated wood element and to initiate the in-situ polymerization of the lactic acid, characterized in that the thermal treatment (3) includes the acceleration of the increase of the heating temperature (T) and/or the decreasing of the nominal temperature (T₀).

2. The method according to claim 1, wherein the acceleration of the increase of the heating temperature (T) is achieved by using a thermal treatment by microwaves radiations.

3. The method according to claim 2, wherein the frequency of the microwave radiations is more than 500 MHz, preferably between 1 and 3 GHz.

4. The method according to any of claims 2 to 4, wherein the thermal treatment by microwaves radiations takes place during 2 to 72 hours, at a temperature between 140 to 180° C.

5. The method according to any of claims 2 to 3, wherein the thermal treatment by microwaves radiations takes place within a microwave oven or tunnel.

6. The method according to any of the preceding claims, wherein the decreasing of the nominal temperature (T₀) is achieved by a thermal treatment under vacuum conditions.

7. The method according to claim 5, wherein the pressure is between 100 and 500 mbar, preferably around 300 mbar.

8. The method according to any of claims 2 to 4, wherein the thermal treatment under vacuum takes place during 24 to 72 hours, at a temperature between 140 to 180° C.

9. The method according to any of the preceding claims, wherein after the wood element is impregnated and before it is thermally treated, the impregnated wood element is pre-heated (4) so as to increase its temperature and then to reduce the time need for the impregnated wood element to reach the polymerization temperature during the thermal treatment.

10. The method according to any of the preceding claims, wherein after the wood element is impregnated and before it is thermally treated, the impregnated wood element is vacuum pre-dried (4) so as to reduce the water content of the impregnated wood element and then to reduce the amount of energy necessary to evaporate water before the polymerization starts.

11. The method according to claim 8, wherein the pre-drying (4) takes place at a low temperature, preferably between 60 and 80° C.

12. The method according to any of the preceding claims, wherein the impregnation (2) with an lactic acid water-based solution is made under vacuum.

13. The method according to any of the preceding claims, wherein the lactic acid water-based solution includes more than 70% of lactic acid.

14. A wood-polymer composite obtainable by implementing the method according to any of the preceding claims.

15. A construction element comprising a set of lamellas made of the wood-polymer composite according to claim 14.
